(19) United States
(12) Patent Application Publication
(10) Pub. No.: US 2008/0221876 A1
(43) Pub. Date: Sep. 11, 2008

(54) Method for processing audio data into a condensed version

(75) Inventor: Robert Holdrich, Graz (AT)

Correspondence Address: RATNERPRESTIA, P O BOX 980, VALLEY FORGE, PA, 19482-0980, US

(73) Assignee: Universitat fur Musik und darstellende Kunst

(21) Appl. No.: 11/715,766

(22) Filed: Mar. 8, 2007

(51) Int. Cl. G10L 19/00

(52) U.S. Cl. 704/201

(57) ABSTRACT

Recorded audio data is compressed to obtain a condensed version, by first selecting a number of subsequent non-overlapping segments of the audio data, then reducing each segment by temporal compression and combining the reduced segments into a shortened version which can be output. The temporal compression may be made with a local compression factor which varies between the segments. The segmenting may be chosen based on an innovation signal derived from the audio data itself to indicate a content change rate in the audio data.

### FIELD OF THE INVENTION AND DESCRIPTION OF PRIOR ART

The present invention relates to an improved method for processing audio data contained in a recording to obtain a shortened (‘condensed’) version which can be audibly presented. The invention also includes a method for processing audio data to obtain a graphically presentable version.

The archives in museums, universities and other institutions comprise a cultural legacy of millions of hours of audio-video material (AVM) stored on media. Great parts of these AVM are not annotated. In order to enable systematic access and survey of these AVM, time-synchronous metadata is added. Automation of this process is difficult and prone to errors which then must be corrected by hand. For correction and checking purposes, the user has to get a survey of the AVM at hand fast. In contrast to video material, where it is possible to produce a survey by composing a number of fixed-images taken from different epochs of the material, it is not suitable or even not possible to produce a meaningful short representation of the audio material in AVM that does not envisage some processing over time.

Investigations concerning AVM, such as studies concerning the usability of screen readers by visually handicapped persons, have shown that the accelerated reproduction of speech reduces comprehensibility significantly already at an acceleration factor of 2-3, even for trained users. With acceleration factors that are slightly higher (max. 4-6), a piece of music may be recognized for certain types of songs. In these two examples, pure time compression without pitch shift was employed.

Known methods for accelerated reproduction of audio material mainly aim at speech (spoken words), with the full comprehensibility of the text being the main concern. The “speech-skimmer” system is described by B. Arons in: ‘SpeechSkimmer: A System for Interactively Skimming Recorded Speech’—ACM Transactions on Computer-Human Interaction, Vol. 4, No. 1, pp. 3-38 1997. It uses time-compressing methods such as the ‘synchronized overlap add’ (SOLA) method, dichotic sampling (requiring binaural reproduction), or extraction of pauses and skimming techniques which leave out parts of the speech signal. Isochronous methods reproduce fixed temporal segments cut from the total signal (e.g., the first five seconds of each one-minute interval); speech-synchronous methods select segments to be reproduced by dividing the speech signal into important and less important parts, based on characteristics such as pause detection, the energy and pitch course, a speaker identification and combinations thereof. Another segmentation method, presented by D. Kimber and L. Wilcox in: ‘Acoustic segmentation for audio browsers’—Proc. Interface Conference, Sydney, Australia, 1996, uses hidden Markov models. The method described by S. Lee and H. Kim in: ‘Variable Time-Scale Modification of Speech Using Transient Information’—1997 IEEE International Conference on Acoustics, Speech, and Signal Processing (ICASSP'97), Volume 2, pp. 1319-1322, 1997, leaves the speech transient unchanged and compresses only the stationary components such as vowels, thus obtaining a better comprehensibility of speech. All these methods are restricted to speech content and will not produce good results for audio materials containing other contents such as music or background sounds.

Gupta, in U.S. Pat. No. 7,076,535, and N. Omoigui et al. in: ‘Time-Compression: System Concerns, Usage, and benefits’—Proceedings of the SIGCHI conference on Human factors in computing systems, pp. 136-143, ACM Press, 1999, describe a client-server-architecture for skimming of multimedia data, but does not discuss the methods actually used apart from the SOLA mentioned above.

### SUMMARY OF THE INVENTION

The present invention envisages implementations of condensing audio data in a manner that does not require a complete comprehensibility of speech or recognition of a music composition; rather, it will be sufficient to provide a rough but representative survey of the material at hand. The AVM types are not restricted to speech or music only. Moreover, compression factors of up to 30 or even more are desired.

This aim is met by a method for processing audio data contained in a AVM recording to obtain an audibly representable shortened version, with the steps of
selecting a number of subsequent non-overlapping segments of the audio data,
reducing each segment by temporal compression, and
combining the segments thus reduced.

The present invention provides a method enabling to produce a condensed representation of large audio and AVM files (i.e. having a duration ranging from several minutes to a few hours) with a high overall compaction factor and which can be played back audibly and/or visually as required.

The method according to the invention is not limited to speech content. Although the time-compression algorithms of SpeechSkimmer may be similar, the skimming methods used for selecting segments are more general and based on the energy course of the signal which is spectrally weighted in various manners so as to detect significant changes of the signal characteristics. Moreover, the segments are overlapped so as to render multiple segments audible at the same time. This is in sharp contrast to the SOLA method which uses segment lengths and overlaps in the range of a few 10 ms.

In one further development of the invention, the temporal compression is made with a local compression factor which varies between the segments. In a special case used to single out a focal center of the audio material, the local compression factor may attain a minimum value (which may be only 1, i.e. no actual compression) for a middle segment. Furthermore, the local compression factor may then be generally decreasing with the segments before said middle segment and generally increasing with the segments after said middle segment.

One suitable way to implement the step of segmenting the audio data is by deriving an analysis signal from the audio data, said analysis signal representing a quantity indicating a content change rate in the audio data, determining time points of maxima of said analysis signal, reducing said time points by respective time displacements, and placing segment boundaries at time points thus reduced.

Various preferred methods for deriving such an analysis signal, also referred to as innovation signal, are discussed in the description below. For example, it may be suitable to perform dividing an audio data signal into a number of frequency band signals, calculating a corresponding number of secondary signals from the frequency band signals using at least one of the following methods: filtering the signal, smoothing the signal, and calculation of a local polynomial from the signal, then combining the secondary signals into a multidimensional power vector P(n), and calculating a distance function between the actual and a past value of said power vector to derive the innovation signal, Inno(n)=dist[P(n)−P(n−m)].

Another suitable method of calculation of the innovation signal uses meta-feature vectors. A suitable way of calculation of the meta-feature vectors is by dividing the segments of the audio data into subsegments, calculating feature vectors for said subsegments, calculating distribution parameters of said feature vectors, and combining said distribution parameters into a meta-feature vector. The innovation signal is calculated by segmenting the audio data in non-overlapping segments, calculating a meta-feature vector F(l) from each of said segments, performing a k-mean clustering of the meta-feature vectors thus obtained, and calculating a marker signal for each segment by assigning a positive value whenever the meta-feature vector is in a cluster different from the cluster of the previous segment, and a zero value otherwise, to obtain the innovation signal. The k-mean clustering may be done multiply, namely, for G different values of the number k_{g} of clusters, with g=1, . . . , G, obtaining G marker signals for each segment; then the innovation signal may be calculated by averaging a superposition of said marker signals Mark_{g}, using a smoothing function Aν, to obtain the innovation signal, Inno(l)=Aν(Σ_{g}Mark_{g}(l)). Further details of this calculational method are discussed in detail in the description.

Segmenting the audio data may be carried out based on non-audio data contained in the recording and synchronous to the audio data as well. In this case, the segment boundaries may be placed at time markers present in said non-audio data.

One simple procedure of combining the reduced segments is adding them together in chronological order with regard to their original position in the audio date, choosing either a forward or reverse order.

An additional compaction of the audio data can be achieved when the step of combining the reduced segments comprises superposition of segments. This may be staggered superposing, wherein the segments start at successive start times and each segment after a first segment has a start time within the duration of a respective previous segment.

Based on the above-described methods, the invention also offers a method for processing audio data to obtain a graphically presentable version, comprising the steps of

deriving an analysis signal from the audio data, said analysis signal representing a quantity indicating a content change rate in the audio data (the analysis signal can be derived by one of the innovation signal methods described herein),
determining time points of maxima of said analysis signal,
placing segment boundaries at time points thus reduced, and
displaying the segments thus defined in a linear sequence of faces of varying graphical rendition.

### BRIEF DESCRIPTION OF THE DRAWINGS

In the following, the present invention is described in more detail with reference to the drawings, which show:

FIG. 1 a block diagram schematic of an implementation of the invention including a compression module;

FIG. 2 the functional principle of the compression module;

FIG. 3 illustrates the use of an innovation signal to fix a segment boundary; and

FIG. 4 an example of a graphical presentation of audio data.

### DETAILED DESCRIPTION OF THE INVENTION

### Compression Engine

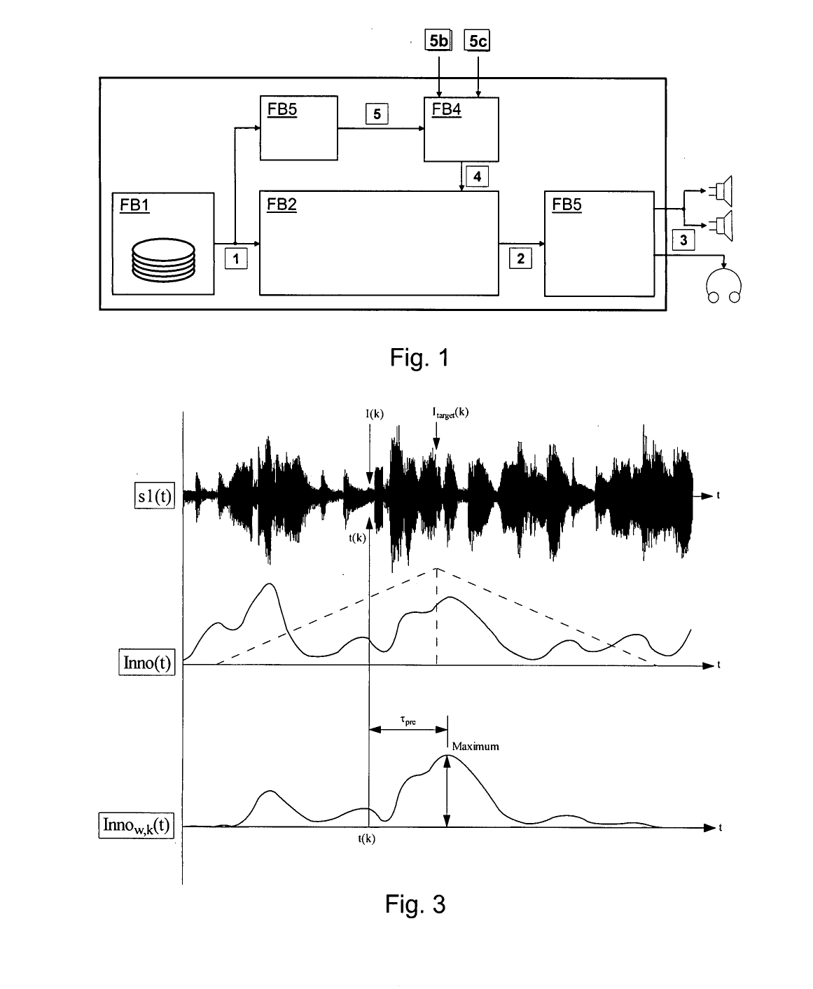

FIG. 1 shows a schematic block diagram of an implementation of the method according to an exemplary embodiment of the present invention. The implementation, also called AudioShrink, may be realized as an apparatus 100, for instance a computer system. It comprises a number of function blocks as follows. A first function block FB1 reads in audio files as audio input signal 1. In the embodiment shown, it is realized by means of hard disk or other permanent memory on which audio files are stored. Another possible realization of the block FB1 is an interface for accessing and retrieving audio data, for instance through internet. Block FB1 may be absent if the audio input 1 is directly provided to the apparatus in the proper electric signal form. A second function block FB2 is a compression module, which accepts the audio material 1 from block FB1 and performs a temporal compression, producing compressed audio output 2. The compression module FB2 may be multi-stage; it is described in more detail below. A third function block FB3 plays the audio output 2, producing an audible (or otherwise perceptible) signal 3. Block FB3 is, for instance, realized by means of a computer sound card with a digital-analog converter connected to appropriate sound producing devices such as loudspeakers or a set of headphones. A fourth function block FB4 serves as control module, controlling the multi-stage compression in block FB2 through control parameters 4 as described below.

Furthermore, optionally a fifth function block FB5 may be provided, which analyses the audio material provided by block FB1 and produces analysis results, realized as an analysis signal 5, as input to the controlling block FB4 in addition to external input entered by the user, such as a desired compression factor 5b or commands 5c to scroll forward or backward. In addition, the analysis signal 5 may be used for a graphical representation of the structure of the audio signal 1.

It is worthwhile to note that in this disclosure, the term compression refers to temporal reduction (i.e., having a shorter duration). This is not to be confused with a dynamic compression of audio material.

### Methods Used in Compression

The temporal compression is performed on the entire audio file presented to the compression module (function block FB2). Three stages, which may be combined with each other, are implemented: (i) pure time shortening, (ii) superposition, and (iii) selection.

i) Pure time shortening: The term pure time shortening shall here refer to a temporal squeeze (accelerated reproduction), which may or may not be accompanied by a shift of (tone) pitch. This may be done by known methods such as variable-speed replay or granular synthesis. Correlation-based methods may also be used, such as synchronous overlap-and-add or, particularly for speech, pitch-synchronous overlap-and-add. Furthermore, frequency range preserving techniques such as phase vocoder may be suitable. In addition to the time compression as such, a pitch transposition may be implemented. A pure time shortening will typically yield compressing factors of 2 to 4.

ii) Superposition: This is the simultaneous rendering of multiple segments with or without varying spatial parameters (in the case of stereophonic or other spatial presentation). This aspect exploits the ability of the human ear to extract information from acoustic information played in the same or overlapping intervals. The audio signal is split into a number of adjacent segments which are superposed so as to be played at the same time. For instance, an audio material of 60 seconds may be converted into 15 s by 4 fold superposition. To help separating of the superposed layers a spatial rendering can be added, such as output of the start of the segment through the left-side channel continuously traversing to the right-side channel at the segment end (“crossing vehicle”).

iii) Selection (omission): Only selected segments of the material are processed; the remaining parts are skipped. The length of the kept segments are suitably chosen so as to allow recognition of the contents of the individual segment while ensuring sufficient homogeneity between neighboring segments to be played, in order to make a categorial change in the audio segments transparent. Selection of audio segments to be kept (as opposed to segments to be left out) may be made based on a choice of parameters provided by the user (fixed parameters) and/or based on analysis parameters (dynamic selection) taken from analysis results 5 of the analysis module FB5 or, in the case of audiovisual or other combined data, information derived from the video or other non-acoustic data. Selective presentation is expected to offer a compression of between 3 and 6 in the case of fixed parameters, whereas factors of about 20 or more are feasible with dynamic selection.

The above compression methods may be combined. For example, a combination of pure time shortening and superposition of different audio segments may be done. In this case, a time variant pitch shift of each segment may enhance the recognizability of the contents of the segments. The pitch shift of each segment may, for instance, vary from a rising shift at the beginning of the segment to a lowering of pitch at the end.

### Control of Compression

Function block FB4 is the control module for controlling the multi-stage temporal compression. Combining the compression stages discussed above allows compaction of audio material by a factor of up to 50 or even more. This means that, for instance, a 5-minute sequence can be presented in 6 seconds, or scrolling through an hour of audio material would only require about 1 to 2 minutes. The control module sets the total compression factor and the presentation direction (forward or backward) in accordance with the user input. Furthermore, it sets a combination of the compression stages i to iii with individual compression factors so as to obtain the total compression factor. The control module also interacts with the user and, if applicable, accepts and interprets the analysis signal 5 from the analysing module FB5.

Analysing module FB5 provides information for the selection of relevant parts of the audio material, and output this information as an analysis signal 5. The major potential of temporal compression is by selective presentation of audio material, i.e., omission of parts. Beside a fixed partitioning in segments to be presented and omitted—such as a segmentation into 2.5 second parts between which 5 seconds are omitted, yielding a compression factor of 3-suitable methods are those that find “relevant” audio information whereas less important or redundant parts are suppressed. The following cases are noteworthy:

### a) Methods Based on Analysis of Audio Material

The audio information may be processed into an ‘innovation signal’ which characterizes the audio information in the sense that a (sufficiently relevant) change in the innovation signal indicates the onset of a period with new contents or new characteristics, and use this innovation signal as analysis signal 5 together with a matching heuristics of the control module FB4. The innovation signal may be determined using known signal processing methods from the fields of audio information retrieval, signal classification, onset or rhythm detection, voice activity detection, or other, as well as suitable combinations thereof. The results of such an analysis may comprise a set of marker points in the audio signal, indicating the start of different periods and, in turn, information of relevance for characterization.

One algorithm of special interest and used in AudioShrink is a method based on progressive multi-level k-means clustering of feature vectors, such as mel-frequency cepstral coefficients. In order to reduce the dimension of the feature vectors employed, a principal component analysis may be used. The results of this method are also suitable for a graphical presentation of audio material (see below). The method used in AudioShrink is an extension of the method presented by G. Tzanetakis and P. Cook in: ‘3d Graphics Tools for Sound Collections’, Proc. Conference on Digital Audio Effects, Verona, Italy 2000, for producing “timbre-grams”. In contrast to Tzanetakis, clustering in the context of AudioShrink works with an progressive k-means algorithm (instead of a k-nearest-neighbor algorithm) and is made in multiple levels. Thus, depending on the compression factor of the acoustic/graphic representation, a varying number of classes and, consequently, segments of varying lengths belonging to one class are used. Of course, other algorithms may be suitable for deriving an innovations signal as well.

b) Methods Using Information from Video or Meta Data

In the case that the material present also comprises synchronous multimedia information such as synchronous media data of video markers, these data may be used as indicators of the start of a scene. The material that immediately follows such a point in time will then be considered relevant and, in consequence, its rendering will be favored.

### Compression Module—Multi-Stage Variable Compression

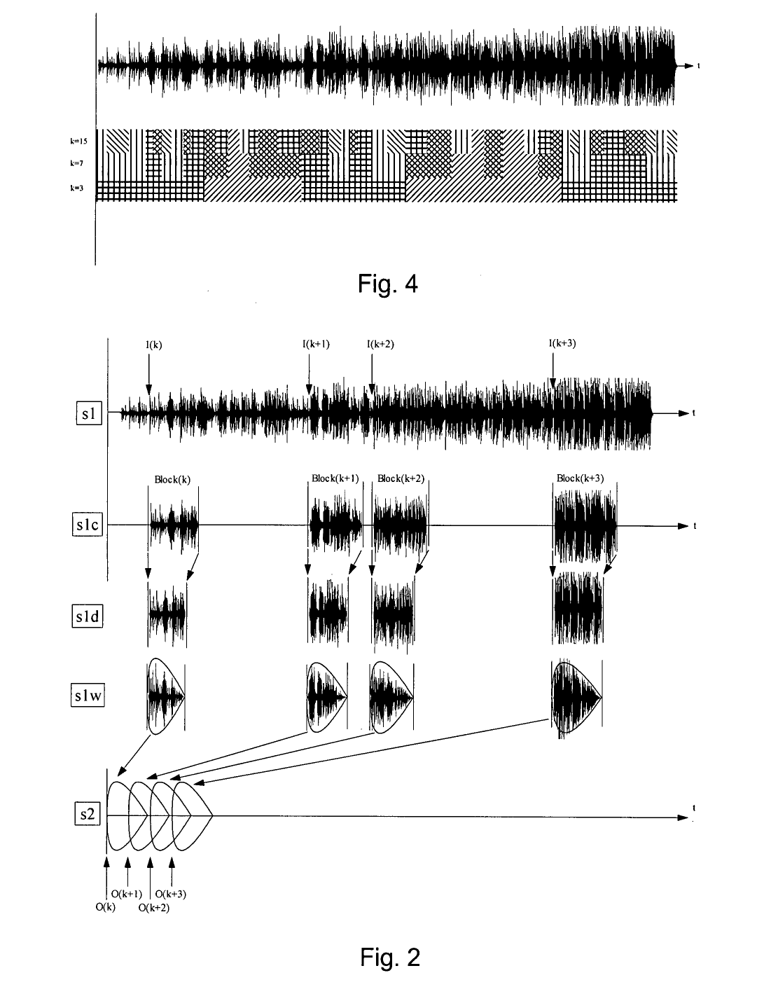

FIG. 2 illustrates an example of how a number of consecutive signal processing stages combine into a multi-stage compression in the compression module (function block FB2). The direction of presentation is “forward” in the example shown. In FIG. 2, audio signals are shown as functions of time t (horizontal axis) at various steps of the multi-stage procedure, with the uppermost signal representing the original audio signal s1. The signal s1 may be a continuous signal over time, s1(t), or discrete at discrete points of time, s1(n), in particular in the case of a digitalized signal, with the time span between subsequent time points n being sufficient small that the listener will conceive the resulting signal s1 as a continuum.

The signal s1 largely fills the time span shown in FIG. 2. The control module FB4 determines a number of selection points I(k), k=1, . . . , K. Each selection point I(k) represents a point in time and indicates the start time of a “relevant” signal block. Since presentation is forward, I(k)>I(k−1) for all selection points. (In the case of backward presentation I(k)<I(k−1).) The total number K of blocks depends on the audio material; in the example shown, K=4.

The blocks Block(k) are selected starting from corresponding selection point I(k) with a common length N, resulting in a chopped signal s1c. The block length N is provided by the control module FB4 as well. In general the length N is chosen such that

N≦N_{CF}+|I(k)−I(k−1)|,

wherein N_{CF} is the crossfade length, i.e., the duration of the minimum overlap required for crossfading.

Then, each block is compressed (pure time shortening) by a squeeze factor C, using appropriate methods such as partial or complete reduction of pauses within a block, SOLA, granular synthesis (asynchronous overlap-and-add), phase vocoder, or resampling (including a pitch shift). The resulting signal is denoted as s1d in FIG. 2. Then each block is windowed according to a window length N_{W} and window shape determined by the control module FB4. The window is illustrated in FIG. 2 as a contour surrounding each windowed block in signal s1w.

Finally, the blocks Block(k) are added (superposed) to the final AudioShrink signal s2. Each block is moved to a time as defined by start times O(k) which are provided by the control module FB4 as well.

The total compression factor Cₜₒₜ relates to the ratio between the average temporal distance ΔI between neighboring selection points in the original signal and the average temporal distance ΔO between neighboring block starts in the AudioShrink signal:

Cₜₒₜ=ΔI/ΔO; ΔI=(1/K)Σₖ(I(k)−I(k−1));

ΔO=(1/K)Σₖ(O(k)−O(k−1));

The average overlap factor Ovp in the AudioShrink signal can be computed by Ovp=N_{W}/ΔO.

### Control Module—Calculation of Multi-Stage Compression Parameters

The control parameters for the compression described above are supplied by function block FB4, the control module, based on the total compression factor Cₜₒₜ, which is usually imposed by the user. Usually, Cₜₒₜ is a constant, but optionally it may be a time-variant value Cₜₒₜ(t). The parameters are: N, the length of selected blocks; N_{CF}, the minimum overlap for crossfading; I(k), the selection points with k=1 . . . K; O(k), the start times with k=1 . . . K; C, the compression factor; N_{W}, the window length; the window shape defined, for instance, as a function w(t) or by specifying an type index for a given set of window shape types. In general, the relation between the control parameters and the total compression factor can be specified in terms of a polynomial function or by means of lookup tables. Typical values of the parameters are given in Table 1.
N_{W}=3 to 6 s;
N_{CF}=30 to 100 ms;
window shape=Hanning, triangle, Tukey, or rectangle with linear fade-in and fade-out;
C=1 for Cₜₒₜ=1, linear increase until
=2 for Cₜₒₜ≧20;

N=N_{W}C+N_{CF};

O(k)=O(k−1)+N_{W}/C²;

I(k)=I(k−1)+Cₜₒₜ(O(k)−O(k−1))=I(k−1)+N_{W}·Cₜₒₜ/C²;
k₁=2 to 5.

### Table 1: Typical Values of Compression Parameters

If an analysis module FB5 is used for selection of relevant audio information, the signal analysis yields information for selection of blocks which supersedes the isochronous block selection, i.e., the choice of parameters I(k) and O(k), in Table 1. The analysis module FB5 produces an innovation signal Inno(t) which is a continuous or discrete sequence indicating a degree of newness of the original audio signal s1(t). If a range in the signal has a high degree of innovation, this range will have a higher probability of being selected, and a selection point I(k) being set accordingly. This causes integration of outstanding sound sequences, i.e., sequences that differ markedly from preceding material, into the AudioShrink signal s2(t). As a consequence, the temporal distance between to neighboring selection points, I(k)−I(k−1), will generally not be uniform for all values of k. In order to maintain the prescribed total compression factor Cₜₒₜ it is important to adjust the ratio between the average temporal distance ΔI between neighboring selection points in the original signal and the average temporal distance ΔO between neighboring block starts. For this, the following approach was found suitable:

When a selection point I(k) is to be chosen, first a provisional value I_{target}(k) is calculated as

I_{target}(k)=Cₜₒₜ·O(k);

In case of a time-variant definition of Cₜₒₜ(t), the provisional value I_{target}(k) is calculated as

I_{target}(k)=Cₜₒₜ·O(k) for k≦k₁;

I_{target}(k)=Cₜₒₜ(t)·[O(k)−O(k−k₁)]+I(k−k₁)

with k₁ being a small integer (typical values of k₁ are given in Table 1). This provisional value is the time which would yield the desired Cₜₒₜ considering the other parameters. FIG. 3 illustrates determining the selection point I(k) starting from a provisional value I_{target}(k) for a signal s1(t) and innovation signal Inno(t) derived therefrom. The innovation signal is multiplied with a window function f(t−t₀) centered at t₀=I_{target}(k). The window function is designed to project out a portion of the innovation signal within a window finite duration 2tw. In the example shown in FIG. 3, the window function is a triangle function as depicted by dashed lines. In general, a window function is chosen such that it is 1 at the center of the window (i.e., f(t−t₀=0)=1), 0 at times outside of the time window around to (i.e., f(t−t₀)=0 when |t−t₀|≧tw), and interpolates between these boundaries values. The resulting modified innovation signal Inno_{w,k}(t)=Inno(t)·f(t−I_{target}(k)) is shown in FIG. 3 as well. The maximum of this function is determined, and the selection point I(k) is calculated by subtracting a short pre-delay τₚᵣₑ:

I(k)=arg max(Inno_{w,k}(t))−τₚᵣₑ

The pre-delay τₚᵣₑ is chosen dependent on the window tape, typically with a value between 0.1 and 1 s. This method will yield a total compression factor Cₜₒₜ that approximates the desired value well.

It is also possible to search the maximum of the non-modified innovation signal Inno(t) in the window around t₀=I_{target}(k). This is equivalent to using a window function which is 1 within the time window (|t−t₀|I<tw) but 0 outside.

If these methods will not yield a total compression that is sufficiently near to the desired value of Cₜₒₜ, the start times O(k) can be adjusted so as to compensate that deviation:

O(k)=I(k)/Cₜₒₜ.

In case of a time-variant definition of Cₜₒₜ(t), adjustment of the start times O(k) are calculated as:

O(k)=[I(k)−I(k−k₁)]/Cₜₒₜ(t)+O(k−k₁).

### Analysis Module—Generation of Innovation Signal

The innovations signal Inno(t) may be discrete-time, such as a sequence of markers produced from metadata, or continuous. While some known methods can produce a signal suitable as innovation signal, such as taking a “floating” average of the signal energy, the following methods were found to be particularly suitable:

A first approach starts from the digitalized sound signal s1(n), where n is the discrete time index, in order to obtain a non-linear quantity y(n) is obtained by

y(n)=s1(n)²−s1(n−1)s1(n+1);

then the time average of this quantity may be used as innovation signal,

Inno(n)=A(n)=Aν(y(n)).

The averaging Aν is done by taking the floating average within a time interval of constant duration around the current time, or exponential smoothing; typical time constants are in the range of 0.3 to 1 s. This method is efficient, involves little calculations expenses only, and it accentuates high-frequency components which are typical for transient activities. Moreover, this method approximates the frequency-dependent sensitivity of the human hearing system.

A more differentiated approach also uses the time derivative of the averaged quantity A(n),

dA(n)/dn=A(n)−A(n−m),

with a suitable value of m such as 0.05 to 0.5 s. This time-derivative will indicate a rise in the energy. The product

B(n)=A(n)·dA(n)/dn

may then be used a innovation signal.

Another approach is based on a division of the sound signal into a number of frequency bands, obtained by methods such as DFT, gammatone filter, octave filter, or wavelet transformation. For each frequency band j=1, . . . , J with associated band signal xⱼ, a floating average of the energy is determined,

Pⱼ(n)=Aν(xⱼ(n)²),

with an averaging period of 0.5 to 3 s. From the set of energies Pⱼ(n), taken as a vector P(n) of dimension J, the innovation signal is calculated through the Euclidian distance between vectors with a given time distance m of typically 0.1 to 1 s,

Inno(n)=∥P(n)−P(n−m)∥

with ∥ . . . ∥ denoting the usual Euclidian norm for a J-dimensional vector.

The gammatone filter is an auditory filter designed by R. D. Patterson. The gammatone filter is known to simulate well the response of the basilar membrane. See: Moore, B. and Glasberg, B. (1983). ‘Suggested formulae for calculating auditory filter bandwidths and excitation patterns’, Journal of the Acoustical Society of America, 74:750-753.

Yet another approach employs clustering of signal feature vectors. The sound signal is split into blocks of equal length, typically of 10 to 30 ms. For each block a signal feature vector is calculated, for instance mel-frequency cepstral coefficients (MFCC), the signal energy of frequency bands, the zero-crossing rate or any suitable combination. The blocks are grouped into ‘meta-blocks’ of preferably 20-100 consecutive blocks, corresponding to a total length of 0.2 to 3 s. The number of meta-blocks is L. For each meta-block, parameters of central tendency, and optionally dispersion parameters, are calculated from the signal feature vectors of the blocks in the meta-block. The parameters thus determined are referred to as ‘meta-feature’; the set of parameters for each meta-block is formed into a ‘meta-feature vector’. The values of each meta-feature occurring through the L meta-blocks is standardized by subtracting the mean value of the respective meta-feature over the L meta-blocks and dividing it by the standard deviation. The standardized meta-feature vector of the l-th meta-block (l=1, . . . , L) is, in the following, referred to as F(l). The vectors F(l) are subjected to a k-means clustering method with a typical number of clusters k=3 to 30. K-means clustering methods are well-known and are based on the concept of partitioning the vectors into clusters so as to minimize the total intra-cluster variance of the vector data. The result of the clustering is a group of k clusters of a varying number of vectors, in this case, of meta-feature vectors. In the simplest case, a clustering run is done once for a predetermined value of k (single level; multi-level clustering see below). A marker signal Mark(l) is generated according to
Mark(l)=k^{-P} if F(l) and F(l−1) are in different clusters,
0 otherwise,
   wherein the exponent p is an external parameter; suitable values are p=0.8 to 3. (The value k^{-P} is arbitrary for single level but is a weight factor in the case of multi-level clustering explained below.) The innovation signal is obtained as the averaged marker signal,

Inno(l)=Aν(Mark(l)).

In this case, a particularly useful way of averaging is exponential smoothing with a smoothing parameter a=0.2-0.8, which can be defined recursively by:

Aν(Mark(l))=a·Aν(Mark(l−1))+(1−a)−Mark(l)

Preferably, multiple clustering runs (‘levels’) will be performed upon the meta-feature vectors of a sound signal, each run for a different value of k, the number of clusters. In other words, a set k_{g}, g=1, . . . , G is given, and a k-means clustering is carried out for each value k_{g}. The G clustering results thus obtained are called levels, hence the name multi-level k-means clustering. For each level, the marker signal Mark_{g}(l) is determined as explained above, and the innovations signal is the averaged sum of the marker signals,

Inno(l)=Aν(Σ_{g}Mark_{g}(l)).

One useful quality of the clustering method is that it can be started even when not all data vectors are present; rather, additional data vectors may be added to a clustering already started or even (provisionally) converged.

Another possibility of an innovation signal is a ‘novelty signal’ as discussed by L. Lu, L. Wenyin, H. Zhang, in: ‘Audio Textures: Theory and Applications’—IEEE Trans. Speech and Audio Processing, Vol. 12, No. 2, March 2004, pp. 156-167. The novelty signal may be derived from signal feature or meta-feature vectors.

### Graphic Presentation of Audio Material

The analysis signal 5, in particular the innovation signal Inno(t), offers a way to generate a graphic representation of an audio signal. By means of such a graphic representation blocks of similar contents can be recognized easily and much more readily than in, for instance, a spectrogram (diagram of the energy over time and frequency) or a depiction of the audio level (loudness). The following method is an extension of the method proposed by B. Logan and A. Salomon, in: ‘A Music Similarity Function Based on Signal Analysis’—Proc. IEEE Int. Conf. On Multimedia and Expo (ICME'01), Tokyo 2001; which extension is used in combination with the multi-level k-means clustering explained above.

FIG. 4 shows an example of a innovation-signal based graphical representation 40 of a signal s1(t). The representation shown is for a three-level k-means clustering with k₁=3, k₂=7, and k₃=15. Each level is represented as a (horizontal) stripe P1, P2, P3, respectively. The stripes display sequences of patterns or colors, each representing a cluster of the respective clustering. Intervals belonging to the same cluster are marked with the pattern or color used to identify the cluster; whenever the meta-vector switches to another cluster, this switch may additionally be marked by a (vertical) border.

The pattern or color may be allotted to the clusters at random, for instance using patterns/colors well distinguishable from each other; alternatively, the pattern or color can be determined from a meta-feature vector representing the cluster (calculated, e.g., as the centroid of the meta-feature vectors F(l) of the cluster). For instance, the cluster meta-feature vectors may be mapped into color space (in a suitable representation such as RGB or CIE-Lab color space with fixed luminance) by appropriate dimension reduction to three or two dimensions, using principal components analysis.

The choice of suitable values of k_{g} for the graphic representation will depend on the compression factor as well. Thus, for instance, for a small compression a combination of color stripes with k_{g}=7, 15, and 30 can give a good overview, while for a high compression k_{g}=2, 4, and 7 may be suitable. FIG. 4 shows an intermediate case with k_{g}=3, 7, and 15.

### EXAMPLES OF APPLICATIONS

### a) SEARCH Engines and Browser Services

Internet has become an important if not major channel of distribution of music and other AVM. The number of distributors, archives and private collections that are available over internet has increased and will increase rapidly. It is conceivable that only a small fraction of these AVM will bear suitable metadata that gives a proper impression of the respective contents. The invention offers a way to obtain an inventory suitable for browsing in order to easier navigate through these inventories.

### b) Surveillance

The security debate not only since 9/11 has caused a sharp increase of surveillance activities in the public, private and commercial domain. The investigation of recorded surveillance material for conspicuous events is, by its very nature and in contrast to video, a time-consuming task. The invention provides an effective approach to produce a survey of vast amounts of AVM in short time.

### c) Integrated Metadata Editors

As already mentioned, the European archives have a huge amount of non-annotated audio-video material. In order to enable systematic access and survey of these AVM, they will have to be provided with time-synchronous metadata. Attempts to automate this process proved difficult and produced errors which again had to be corrected by hand. For correction and checking purposes, the user has to get a survey of the AVM at hand. The invention allows producing such a survey fast and on an on-demand basis. Thus, the production expenses of annotation of AVM can be distinctly reduced.

It is possible to tune the accuracy of the representation dependent on the focus point of the user. The user selects a point in time of the AVM as focus, thus marking it as ‘present’ which will be reproduced unchanged (uncompressed) in real time. The parts which are ‘past’ or ‘future’ to that focus are compressed, using increasing compression with increasing (temporal) distance from the focus. For instance, a time interval at 5 to 4 min before the present may be compacted to 10 s, whereas an interval between 15 and 18 min relative to the present is contracted to 7 s. By virtue of this non-linear compression, which is similar to a zoom-out function in graphics, the user can obtain a rough survey of the contents out of the focus that is currently associated with the AVM at hand.

In the context of a focus-dependent compression mentioned above, a pitch shift may indicate the temporal distance from the focus (‘present’). Thus, far ‘past’ or ‘future’ could have higher pitch as parts comparatively near to ‘present’, not unlike a high-speed replay of a tape recording.

### d) Acoustic Thumbnails

The invention also offers a simple way to produce short representations which can be used as acoustic “fingerprints” or “thumbnails”. These acoustic fingerprints offer an intuitive access way to the underlying AVM files since the method according to the invention reduces a temporal interval in a manner that maintains perceptible the basic categorial flow of the AVM but suppresses details of minor importance. Such an acoustic thumbnail needs only a short time for loading or transmission and could—like the so-called thumbnail icons used in image inventories—be used as an “earcon”, allowing to retrieve a time saving advance information. These “earcons” can be produced and distributed or sold separately, possibly as a web service. They could also be used as personal ring tones in a mobile phone or like applications.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

We claim:

1. A method for processing audio data contained in a recording to obtain a shortened audibly presentable version, comprising:
selecting a number of subsequent non-overlapping segments of the audio data;
reducing each segment by a temporal compression; and
combining the segments thus reduced.

2. The method of claim 1, wherein the temporal compression is made with a time-variant compression factor which varies between the segments.

3. The method of claim 1, wherein selecting of segments of the audio data comprises:
deriving an innovation signal from the audio data, said innovation signal representing a quantity indicating a content change rate in the audio data;
determining time points of maxima of said innovation signal;
selecting segments respectively containing said time points;
reducing said time points by respective time displacements; and
placing segment onsets at time points thus reduced.

4. The method of claim 3, wherein starting from an audio data signal s1(n) the calculation of the innovation signal comprises:
deriving a non-linear quantity y(n)=s1(n)²−s1(n−1)·s1(n+1);
averaging said non-linear quantity with a smoothing function Aν to obtain an averaged quantity A(n)=Aν[y(n)]; and
utilizing said averaged quantity as innovation signal Inno(n).

5. The method of claim 3, wherein starting from an audio data signal s1(n) the calculation of the innovation signal comprises:
deriving a non-linear quantity y(n)=s1(n)²−s1(n−1)·s1(n+1);
averaging said non-linear quantity with a smoothing function Aν to obtain an averaged quantity A(n)=Aν[y(n)]; and
combining said averaged quantity with its past values A(n−m) to calculate an innovation signal Inno(n)=A(n)²−A(n)·A(n−m).

6. The method of claim 3, wherein the calculation of the innovation signal comprises:
dividing an audio data signal into a number of frequency band signals;
bandpass filtering the frequency band signals;
calculating a moving average of an instantaneous power of the signals thus filtered using a smoothing function Aν;
combining the signals thus obtained into a multidimensional power vector P(n); and
calculating a distance function between the actual and a past value of said power vector to derive the innovation signal, Inno(n)=dist[P(n)−P(n−m)].

7. The method of claim 3, wherein the calculation of the innovation signal comprises:
dividing an audio data signal into a number of frequency band signals;
calculating a corresponding number of secondary signals from the frequency band signals using at least one of the following methods: filtering the signal, smoothing the signal, and/or calculation of a local polynomial from the signal;
combining the secondary signals into a multidimensional power vector P(n); and
calculating a distance function between the actual and a past value of said power vector to derive the innovation signal, Inno(n)=dist[P(n)−P(n−m)].

8. The method of claim 3, wherein the calculation of the innovation signal comprises:
segmenting the audio data in non-overlapping segments;
calculating a meta-feature vector F(l) from each of said segments;
performing a k-mean clustering of the meta-feature vectors thus obtained; and
calculating a marker signal for each segment by assigning a positive value whenever the meta-feature vector is in a cluster different from the cluster of the previous segment, and a zero value otherwise, to obtain the innovation signal.

9. The method of claim 8, wherein the k-mean clustering is done for G different values of the number k_{g} of clusters, with g=1, . . . , G, obtaining G marker signals for each segment, and the innovation signal is calculated by averaging a superposition of said marker signals, using a smoothing function Aν, to obtain the innovation signal, Inno(l)=Aν(Σ_{g}Mark_{g}(l)).

10. The method of claim 9, wherein the calculation of the G marker signals is done using
Mark_{g}(l)=h(k_{g}) if F(l) and F(l−1) are in different clusters
0 otherwise
with an monotonically decreasing function h.

11. The method of claim 8, wherein the calculation of the meta-feature vectors comprises dividing the segments of the audio data into subsegments,
calculating feature vectors for said subsegments;
calculating distribution parameters of said feature vectors; and
combining said distribution parameters into a meta-feature vector.

12. The method of claim 1, wherein the step of segmenting the audio data is based on non-audio data contained in the recording and synchronous to the audio data, wherein segment onset are placed at time markers present in said non-audio data.

13. The method of claim 1, wherein the step of combining the reduced segments is done in chronological order with regard to their original position in the audio date, choosing either a forward order or a reverse order.

14. The method of claim 1, wherein the step of combining the reduced segments comprises superposition of segments.

15. The method of claim 14, wherein the superposition of segments is comprises staggered superposing, wherein the segments start at successive start times and each segment after a first segment has a start time within the duration of a respective previous segment.

16. A method for processing audio data to obtain a graphically presentable version, comprising:
deriving an innovation signal from the audio data, said innovation signal representing a quantity indicating a content change rate in the audio data;
determining time points of maxima of said analysis signal;
placing segment boundaries at time points thus determined; and
displaying the segments thus defined in a linear sequence of faces of varying graphical rendition.
